(19) United States
(12) Patent Application Publication
(10) Pub. No.: US 2012/0316906 A1
(43) Pub. Date: Dec. 13, 2012

(54) SPATIAL-TEMPORAL OPTIMIZATION OF PHYSICAL ASSET MAINTENANCE

(75) Inventors: ARUN HAMPAPUR, Yorktown Heights, NY (US); Hongfei Li, Yorktown Heights, NY (US); Andrew J. Davenport, Yorktown Heights, NY (US); Shilpa Mahatma, Yorktown Heights, NY (US); Lexing Xie, Hawthorne, NY (US); Rogerio S. Feris, Hawthorne, NY (US); Wei Shan Dong, Haidian District Beijing (CN); Zhong Bo Jiang, Haidian District Beijing (CN); Hao Wang, Haidian District Beijing (CN); Jing Xiao, Haidian District Beijing (CN); Chunhua Tian, Haidian District Beijing (CN)

(73) Assignee: International Business Machines Corporation, Armonk, NY (US)

(21) Appl. No.: 13/569,891

(22) Filed: Aug. 8, 2012

Related U.S. Application Data
(62) Division of application No. 12/874,979, filed on Sep. 2, 2010.

(51) Int. Cl. G06Q 10/06

(52) U.S. Cl. 705/7.12; 705/7.28

(57) ABSTRACT

A method for determining a maintenance schedule of geographically dispersed physical assets includes receiving asset data including infrastructure relationships between the assets, modeling failure risk of the assets based on spatial, temporal and network relationships, and producing the maintenance schedule according to a combination of the risk model, asset data, maintenance, and external operation constraints. The maintenance schedule may be corrective and/or strategic.

### CROSS-REFERENCE TO RELATED APPLICATION

This is divisional application of U.S. application Ser. No. 12/874,979, filed Sep. 2, 2010, the disclosure of which is herein incorporated by reference in its entirety.

### BACKGROUND

1. Technical Field

The present disclosure generally relates to asset maintenance, and more particularly to spatial-temporal optimization of asset maintenance.

2. Discussion of Related Art

Physical asset management poses operational challenges over time, space and resources. These problems are widely applicable in transportation, energy, public facilities and many other industry and consumer sectors. For managing geographically dispersed physical assets, one question is where and when to schedule the maintenance. Such scheduling should operate within the limited resource constraints, while trying to maintain the overall service quality. Prior proposed approaches to physical asset maintenance used heuristics trigger requests to produce locally optimized schedules within production systems.

Prior practices in this area are mainly based on experience and executed with heuristics, due to two main difficulties: collecting large amount of data (both about the assets and the environments), and quantifying the cost and benefit of performing work. Existing proposed approaches for optimization of asset management include: maintenance request generation based on predetermined trigger criteria and schedule such request based on constraints in a production system; predictive-maintenance structures that enable optimal inspection and replacement decision in order to balance the cost engaged by failure and unavailability on an infinite horizon; evolutionary algorithms to preventive maintenance designed to optimize preventive maintenance for mechanical components using genetic algorithms, or the use of integer programming to schedule preventive maintenance.

Therefore, a need exists for a maintenance optimization combining a spatial-temporal statistical model for asset lifecycle estimation with spatial-temporal scheduling optimizer.

### BRIEF SUMMARY

According to an embodiment of the present disclosure, a method for determining a maintenance schedule of geographically dispersed physical assets includes receiving asset data including infrastructure relationships between the assets, modeling failure risk of the assets based on spatial, temporal and network relationships, and producing the maintenance schedule according to a combination of the risk model, asset data, maintenance, and external operation constraints.

According to an embodiment of the present disclosure, a method for determining a maintenance schedule of geographically dispersed physical assets includes receiving a model of asset failure risk based on asset data including spatial, temporal and network relationships between the assets, and producing the maintenance schedule according to a combination of the risk model, asset data, maintenance, and external operation constraints.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a flow diagram of a method for maintenance schedule optimization according to an embodiment of the present disclosure;

FIG. 2 is a flow diagram of an exemplary implementation of a maintenance schedule optimization according to an embodiment of the present disclosure;

FIG. 3 depicts an exemplary scenario of a risk-based weighted routing according to an embodiment of the present disclosure; and

FIG. 4 is a diagram of a system for performing a maintenance schedule optimization according to an embodiment of the present disclosure.

### DETAILED DESCRIPTION

According to exemplary embodiments of the present disclosure, a maintenance schedule of assets dispersed in a geographical spatial network may be determined and/or optimized. Examples of assets include public assets such as fire hydrants, traffic lights and road networks, and industry sectors including pipes, wires and cellular towers. According to exemplary embodiments of the present disclosure, the maintenance schedule supports the application of modeling techniques to predict infrastructure failure (e.g., rate of failure based on the networked relationship of assets and their environments), maintenance planning for strategic maintenance decisions, etc.

Consider an example of asset management; in utilities, unplanned outages can be a significant cost driver, thus operators would prefer to predict potential issues and address the outages before they occur. Being able to assess the condition of the infrastructure is a basis for predicting potential failures. However based on the type of asset, the feasibility and cost of condition assessment can vary significantly. According to exemplary embodiments of the present disclosure, condition assessment data, historic failure data and sensor data in conjunction with asset configuration data and external data like weather, other geospatial data may be leveraged to create predictive models of failure and to discover hidden patterns.

One challenge in asset management is to understand the lifecycle of the asset components. To model the behavior of physical assets, the impacts of various external factors need to be considered. Such impacts can come from geographical factors such as terrain, altitude, location, from environmental factors such as temperature, weather, from connections to other assets such as tanks, pipes, valves, as well as from human activity factors such as usages, damages, and accidents. In addition, spatial and temporal correlations among asset components can provide supplemental information for use in modeling to compensate for incomplete information such as historical records. The spatial and temporal correlations among asset components may further include information about the location of other infrastructural parts, heavy users, unusual demands on use, and the like. For example, asset adjacency may be determined based on the spatial, temporal and network relationships between the assets, wherein the relationships control the influence of assets on one-another, such as in the case of a pipe failure due to an increase in pressure due resulting from the failure of connected valves or hydrants. In this case, a failure probability of adjacent assets may also increase.

Another challenge in asset management comes from connecting the behavior of physical assets to actionable work items. This connection not only builds upon an accurate estimate of resource needed for completing each work item, such as labor, parts, and expendable items, but also need value estimates for completing a work item.

According to exemplary embodiments of the present disclosure, reliable modeling of assets lifecycle over space-time is achieved under the influence of external factors, while translating the lifecycle estimates of physical assets to an actionable work schedule is performed given resources available over space and time.

Through maintenance schedule determination and/or optimization, a lifecycle of physical assets can be improved through efficient resource and energy use. Exemplary embodiments of the present disclosure can be integrated into business optimization systems and asset software, such as International Business Machines Corporation's TIVOLI ASSET MANAGEMENT and MAXIMO ENTERPRISE ADAPTER products.

Infrastructure Failure

According to exemplary embodiments of the present disclosure, a spatial-temporal model estimates the asset lifecycle while taking into account spatio-temporal variation and external factors with associated inference algorithms. Spatio-temporal correlation among asset components can provide supplemental information to compensate for incomplete information due to partial samples of asset for maintenance from historical records. Given the estimated lifecycle, work item scheduling can be improved over real-world work models and resource constraints.

According to exemplary embodiments of the present disclosure, a search strategy may use statistical sampling and guided stochastic search of the asset data that may be used to optimize the maintenance schedule. For example, data mining of the asset data allows a user to search large databases and to discover hidden patterns in the asset data. Data mining is thus an automated tool for the discovery of valuable, non-obvious information and underlying relationships in the asset data. Other optimization methods may be used, for example, using a Monte Carlo simulation to calculate risk in an infrastructure system using the model of failure risk or a relaxed integer program for transforming an NP-hard optimization into a related problem that is solvable in polynomial time.

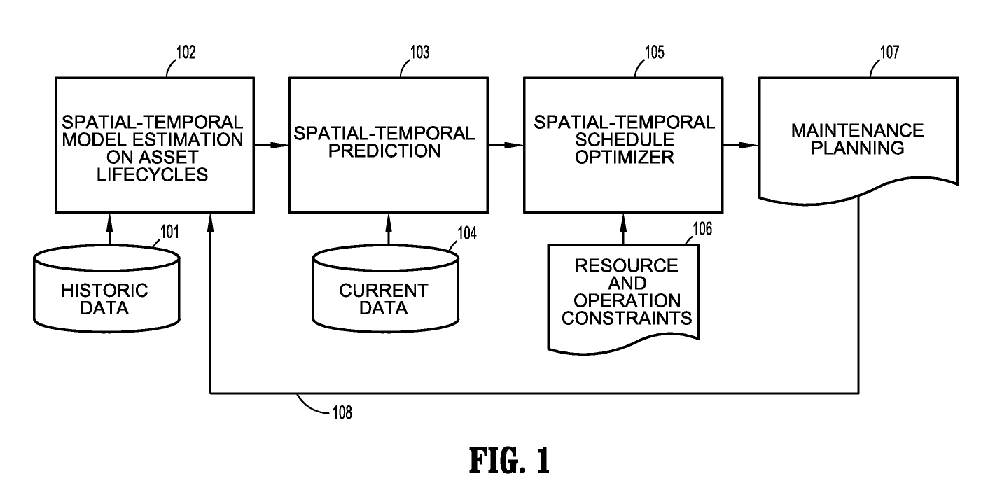

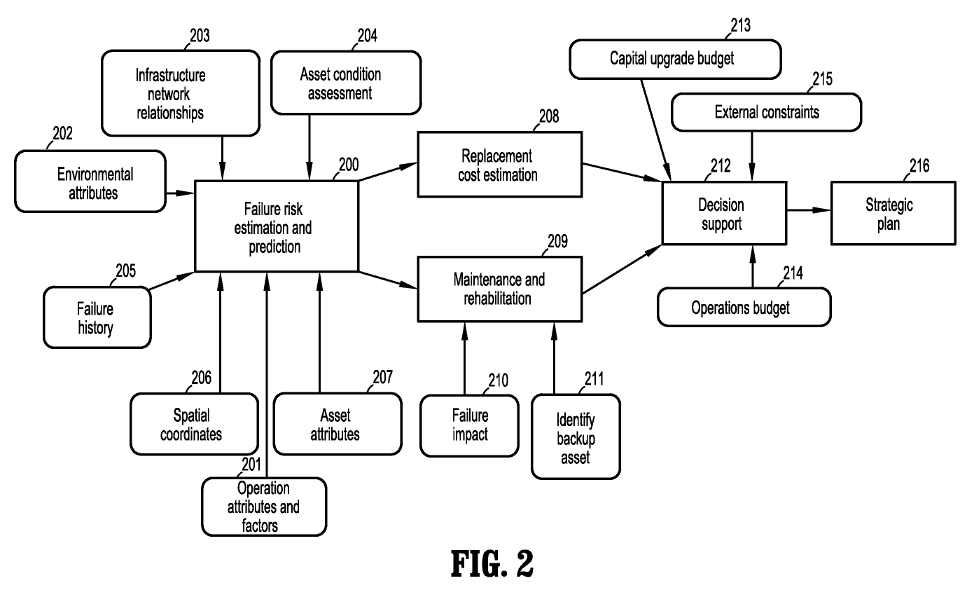

Referring to FIG. 1, a spatial-temporal asset optimization includes receiving historical maintenance records (101) for the asset status and external factors that may have impacts on the asset status. Note that FIG. 1 is an exemplary instance of an implementation of the methods discussed with respect to FIG. 2.

A statistical model is determined (102) to estimate asset lifecycle by considering spatio-temporal correlation and external impacts. For example, consider equation (1) below, which says the failure probability of component i given its neighbors equals the external factor impacts and its neighbors' impact. Under incomplete data, spatial correlation is used to impute missing data.

Consider assets i ε{1, 2, . . . , n}, with coordinates lᵢ=(lᵢ₁, lᵢ₂), indicator yᵢ=1 denotes the event that the i-th asset fails, its failing risk being: P(yᵢ=1)=rᵢ.

An exemplary model for estimating rᵢ can be from both assets i's neighbors N(i) and external factors Xᵢ:

$${r}_{i} \vert {r}_{N ( i )} = {X}_{i} β + α {\sum }_{j ∈ N ( i )} ( {r}_{j} - {X}_{j} β ) ; \qquad ( 1 )$$

where β is (non-linear) regression coefficients; α is the spatial correlation parameter; and j εN(i), iff∥lⱼ−lᵢ∥²≦σ². Here Xᵢβ is the non-spatial risk and

$${\sum }_{j ∈ N ( i )} ( {r}_{j} - {X}_{j} β )$$

is the spatial risk.

At block 103, an estimate of the current asset states is determined using the models learned in at block 102 and optionally current data (104). Current data (104) includes the change of asset state and external conditions, such as new failure records, weather feeds, etc. More particularly, current data includes additions to historical data (e.g., problem history) and updates to instantaneous data (e.g., weather for today). That is, as shown in FIG. 1, current data is data recorded after the spatial-temporal model estimation 102. Historic data (101) includes the past maintenance history of assets that relate to future failure, such as past maintenance records and failure history of the same type of assets, which is used for the spatial-temporal model estimation 102. The estimate of the current asset states may be determined as follows:

Given a set of n assets x₁, x₂, . . . , xₙ at location l₁, l₂, . . . . , lₙ, their estimated failure risk is r₁, r₂, . . . , rₙ, where r is a function over space and external factors. The schedule optimization problem for time t then becomes:

$${min}_{s . t .} \cdot {\sum }_{j ∈ st}^{{ω}_{r} {R}_{st} + {ω}_{w} {W}_{st} + {ω}_{d} {D}_{st}} {c}_{j} \leq C \qquad ( 2 )$$

where st is a selected subset of assets, Rₛₜ, Wₛₜ and Dₛₜ are the risk, work cost and routing/distance cost associated with the selection st, and ωᵣ, ω_{w} and ω_{d} are weighting factors among parts of the objectives.

The estimate (2) uses relaxation to overcome the combinatorial nature of St. The estimate (2) factors in external variables for risk estimation, impute for missing data, and temporal variability for routing cost, e.g., traffic. Multi-objective optimization is used to solve (2), with user intervention. For example, a user can decide which schedule to be chosen from the optimal pareto set based on a preference or trade-off among multiple objectives.

Given the lifecycle estimates from block 103, available resources and operation constrains (106), an optimized maintenance schedule (107) is determined over space and time at block 104. The statistical model and schedule optimizer is updated when receiving new records using a feedback loop (108).

The historical maintenance records (101) for the asset status can be reported at regular or irregular time basis. For each of the record, it is possible that only a subset of the asset is updated. Thus the incomplete information should be considered for modeling. The historical maintenance records (108) are used to develop the spatio-temporal model to estimate the asset lifecycle. The past maintenance records (108) give the information about the likelihood of the failure rate of asset components. Geographical spatial information and time series maintenance records supplement the limited knowledge on the lifecycle of the asset components. External factors can provide additional information to help with the estimation.

At block 102, models are developed to estimate asset life cycles, these can include traditional risk and lifecycle models such as the Cox model with asset properties and operating conditions, or can incorporate the cumulative effect of external factors such as weather and traffic, or can incorporate the observed failure rate of other assets in the close vicinity.

At block 105, an optimal solution (107) to when and where scheduling problem is provided given the above procedures.

This approach is adaptive, using a feedback loop (108). With the maintenance records (107) updated, the statistical model output at block 102 and the scheduling optimizer at block 105 need to be refitted to incorporate the feedback loop data (108).

Strategic Maintenance

According to an embodiment of the present disclosure, asset failure risks can be estimated and understood given external factors and spatio-temporal correlations such as which assets tend to fail, when to inspect and replace assets, etc. Further, the spatial-temporal information is made actionable, such as in the optimization of scheduling and routing, for example, where to direct maintenance trucks. Thus, strategic maintenance may be used to estimate a failure of assets (e.g., based on time, infrastructure network relationships, asset condition assessment, etc.) and make a determination to repair/performed preventive maintenance or replace the asset based on the estimated failure.

FIG. 2 is a flow diagram of an exemplary implementation of a maintenance schedule optimization according to an embodiment of the present disclosure. At block 200, a failure risk estimation and prediction module takes various inputs, including operational attributes/factors (201), environmental attributes (202), infrastructure network relationships (203), asset condition assessment (204), failure history (205), spatial coordinates (206) and asset attributes (207). Replacement cost estimations (208) and maintenance cost estimations (209) may be determined based on the failure risks. Further, the maintenance cost estimations (209) may take additional inputs, such as failure impact (210) and identify backup asset (211).

More particularly, operational attributes/factors (201) include factors such as average water pressure, maximal water pressure, average PH value, etc. in pipe failure prediction, environmental attributes (202) may include weather, soil type, etc., infrastructure network relationships (203) can include connections between assets such as pipes, conduits, etc., while asset condition assessment (204) includes the overhead needed to assess the assets.

A decision support module (212) utilizes predicted infrastructure failure in determining a strategic maintenance plan (216). That is, given various inputs, the decision support module (212) may minimize a combination of cost and service disruption on a given time horizon (e.g., 6 months, 5 years or 10 years). For example, the decision support module (212) may be implemented as a multi-objective optimization as used to solve (2) above with appropriate variables for the replacement cost estimations (208), maintenance and rehabilitation cost estimations (209), budgets (213 and 214) and external constraints (215). That is, the decision support module (212) can take the replacement cost estimations (208) and/or maintenance and rehabilitation cost estimations (209) as input, and optionally additional inputs, such as budgets (213 and 214) and external constraints (215), and produces the strategic maintenance plan (216) that may minimize the combination of cost and service disruption. One of ordinary skill in the art would recognize that the inputs in the combination may be weighted. For example, the decision support module may recommend to replace an asset if the long-term maintenance and rehabilitation cost (209) exceeds the one-time replacement expense (208). Causes of such occasions can include: more frequent failures of older assets, or defects in a class of asset (e.g., iron pipes when soil conditions become more acidic), or that temporary replacement cost reduction by external factors (215)—such as having road repairs already in place cuts the cost of opening and restoring public spaces, or that a pipe near a hospital should be weighted or prioritized for replacement to meet a service level guarantee. The strategic plan (216) may be updated to in view of new observations, budgeting conditions, requirements, etc.

Consider for example fire hydrants located in Washington D.C. The District includes about 10,000 fire hydrants with known locations, make/model, and prior inspection dates. In the on-going maintenance of these fire hydrants, about 15,000 data entries were made between July and September of 2009. Taking this data into consideration, the exemplary implementation assigns different risk levels to each of the fire hydrants, for example, high risk and low risk. An inspection schedule is determined based on the risk assignment so that high risk fire hydrants are given priority in an inspection schedule while taking into consideration constraints such as distance traveled (e.g., carbon footprint of the schedule) and overall cost. That is, routing of the inspection schedule is risk-based, and further considers additional factors to arrive at a weighted traveling salesman problem. That is, given failure predictions of certain assets, a strategic maintenance plan may be determined for the assets wherein each asset is visited once in a shortest tour of the assets; for example, the failure predictions may be used as weights on the distances between assets.

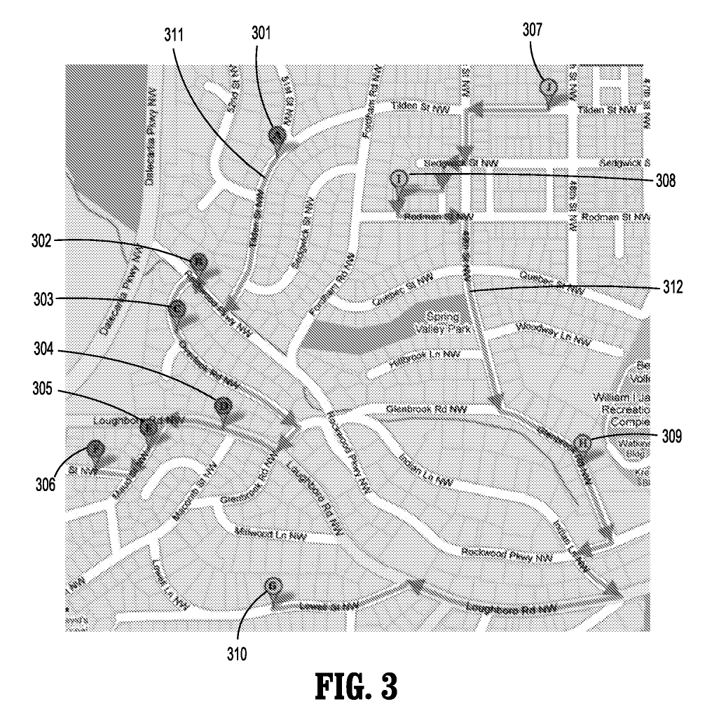

FIG. 3 depicts an exemplary scenario in which assets, e.g., fire hydrants, have different risk levels. Higher risk assets A-F are denoted as 301-306 and may appear in a unique color or other indicia to signify the level of risk. Lower risk G-J are denoted as 307-310 and may also have a unique indicia to signify the respective level of risk. Assume that two different candidate routes are determined for these assets 301-310. These routes are shown as ABCDEF and JIHG and linked by potential routes 311 and 312. Between the two candidates ABCDEF may be determined to be superior; for example, ABCDEF includes more assets than JIHG, the assets are at higher risk, and further, the distance between the assets is shorter, reducing overall cost. Thus, the routing is risk-based and weighted to take into account additional routing/scheduling factors such as traffic.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system”.

Furthermore, aspects of the present invention may take the form of a computer program product embodied in one or more non-transitory computer readable medium(s) having computer readable program code embodied thereon.

It is to be understood that embodiments of the present disclosure may be implemented in various forms of hardware, software, firmware, special purpose processors, or a combination thereof. In one embodiment, a VEE for streaming languages may be implemented in software as an application program tangibly embodied on a non-transitory computer readable medium. As such the application program is embodied on a non-transitory tangible media. The application program may be uploaded to, and executed by, a processor comprising any suitable architecture.

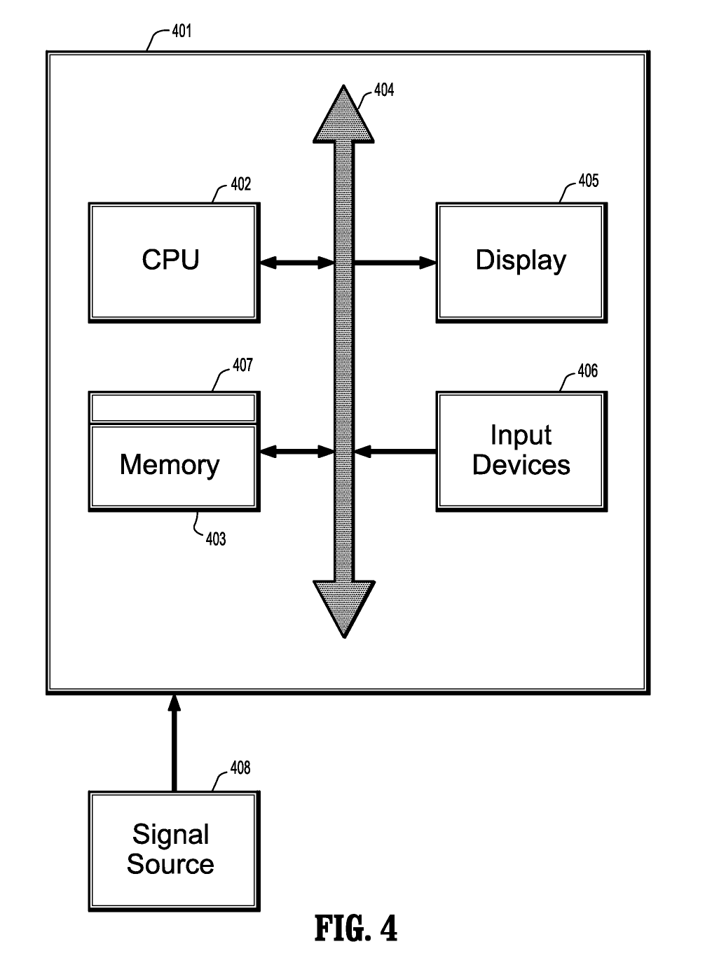

Referring to FIG. 4, according to an embodiment of the present disclosure, a computer system (401) for implementing spatial-temporal optimization of asset maintenance can comprise, inter alia, a central processing unit (CPU) (402), a memory (403) and an input/output (I/O) interface (404). The computer system (401) is generally coupled through the I/O interface (404) to a display (405) and various input devices (406) such as a mouse and keyboard. The support circuits can include circuits such as cache, power supplies, clock circuits, and a communications bus. The memory (403) can include random access memory (RAM), read only memory (ROM), disk drive, tape drive, etc., or a combination thereof. The present invention can be implemented as a routine (407) that is stored in memory (403) and executed by the CPU (402) to process the signal from the signal source (408). As such, the computer system (401) is a general-purpose computer system that becomes a specific purpose computer system when executing the routine (407) of the present invention.

The computer platform (401) also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for spatial-temporal optimization of asset maintenance, it is noted that modifications and variations can be made by persons skilled in the art in light of the above teachings. It is therefore to be understood that changes may be made in exemplary embodiments of disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A non-transient computer program product for determining a modeling failure risk of geographically dispersed physical assets, the computer program product comprising:
a computer readable storage medium having computer readable program code embodied therewith, the computer readable program code comprising:
computer readable program code configured to receive asset data including spatial, temporal and network relationships between the assets; and
computer readable program code configured to model failure risk of the assets based on the spatial, temporal and network relationships, wherein a model of failure risk identifies an asset likely to require maintenance.

2. The computer program product in claim 1, wherein the computer readable program code configured to model the failure risk of the assets, further performs the modeling of the failure based on environmental data.

3. The computer program product in claim 1, wherein the computer readable program code configured to model the failure risk of the assets, performs the modeling of the failure based on asset condition data.

4. The computer program product in claim 1, wherein the model of failure risk outputs a replacement cost estimate for each of the assets.

5. The computer program product in claim 1, wherein the model of failure risk outputs a maintenance cost estimate for each of the assets.

6. A non-transient computer program product for determining a maintenance schedule of geographically dispersed physical assets, the computer program product comprising:
a computer readable storage medium having computer readable program code embodied therewith, the computer readable program code comprising:
computer readable program code configured to receive a model of asset failure risk based on asset data including spatial, temporal and network relationships between the assets; and
computer readable program code configured to produce the maintenance schedule according to a combination of the risk model, asset data, maintenance, and external operation constraints.

7. The computer program product in claim 6, wherein the model of failure risk includes a replacement cost estimate for each of the assets.

8. The computer program product in claim 6, wherein the model of failure risk includes a maintenance cost estimate for each of the assets.

9. The computer program product in claim 6, wherein the maintenance schedule is based on a replacement cost estimate for each asset, a maintenance cost estimate for each asset and budget data.
